(19) United States
(12) Patent Application Publication
(10) Pub. No.: US 2014/0046651 A1
(43) Pub. Date: Feb. 13, 2014

(54) SOLUTION FOR MAX-STRING PROBLEM AND TRANSLATION AND TRANSCRIPTION SYSTEMS USING SAME

(71) Applicant: Marc Dymetman, Grenoble (FR)

(72) Inventor: Marc Dymetman, Grenoble (FR)

(73) Assignee: Xerox Corporation, Norwalk, CT (US)

(21) Appl. No.: 13/572,817

(22) Filed: Aug. 13, 2012

(51) Int. Cl. G06F 17/28; G06F 17/27

(52) U.S. Cl. 704/2; 704/9

(57) ABSTRACT

An unweighted automaton B is generated from a weighted finite state automaton (WFSA) A, having the same states as the WFSA and having unweighted transitions corresponding only to the transitions of the WFSA having strictly positive weights. A powerset construction on the unweighted automaton generates a deterministic automaton B′ having states Q. For each state Q′, a set of points L_{Q′} is defined representing all vectors w′=w·a_{QQ′} where a_{QQ′} is a transition label of a dominator of a predecessor state Q connecting Q with state Q′ and w is a prefix of the transition label a_{QQ′} in Q, and a set of dominators S_{Q′} in L_{Q′} are determined such that L_{Q′} is included in hull(S_{Q′}). The dominant vector is identified in final state Q_{f} such that L_{Q}_{_{f}} is included in hull(w_{f}). Backpointers from the dominant vector w_{f} to the initial state Q₀ are followed to generate the max-string result.

### BACKGROUND

The following relates to the translation arts, transcription arts, weighted finite state automaton (WFSA) processing arts, optimization arts, and related arts.

Tasks such as natural language translation, audio transcription, and so forth are sometimes formulated as weighted finite state automaton (WFSA) representations. A WFSA comprises a network of states linked by connecting transitions (also called “arcs” or “edges”) having weights. In the case of a translation task, the WFSA may represent translation lattices, source/target language transducers (in which transitions are labeled by source/language pairs, note that as used herein WFSA encompasses weighted finite state transducers), or another formalism. The WFSA is suitably constructed based on inputs such as a database of source language-target language phrase pairs with likelihood weights. The formulation of a transcription task is similar, but for transcription the “source” content comprises audio segments while the “target” comprises transcribed text corresponding to the audio segments.

The various possible paths through the WFSA correspond to possible translations or transcriptions whose probability can be gauged based on the weights of the transitions. The translation or transcription task thus reduces to identifying the “best” string obtainable by traversing the WFSA, where the elements of the string are the traversed states of the WFSA. For many WFSA applications including the foregoing translation or transcription formalisms, the “best” string is conceptually the string x that maximizes the sum of the weights of all paths that yield the string x. This is known as the max-string solution, and can be viewed as performing the optimization in the sum-times semiring Kₛ≡( [symbol] ₊,+,·,0,1).

Finding the max-string solution has been found to be difficult in practice. Accordingly, the max-path solution has been employed as a proxy for the max-string solution in problems such as translation and transcription. This is called the Viterbi approximation, and is widely used in speech recognition, machine translation, and other natural language processing (NLP) tasks. The max-path solution is the path π of maximum weight in the WFSA, that is, the path 7r that maximizes the product of the weights associated to its transitions. The max-path solution can be viewed as performing the optimization in the max-times semiring Kₘ≡( [symbol] ₊,max,·,0,1).

Although the max-path provides a reasonable proxy for the max-string solution for some applications, it is not ideal and can yield less-optimal results. The optimal translation or transcription is expected to be the max-string solution, and accordingly it would be advantageous to employ the max-string solution rather than the Viterbi approximation.

The following discloses improved techniques for generating the max-string solution, which are computationally efficient and accordingly can be used in tasks such as translation or transcription tasks. While translation and transcription are described as illustrative applications of the disclosed max-string evaluation techniques, it is to be understood that the disclosed max-string evaluation techniques are suitably used in any application for which the max-string solution of a WFSA is useful.

### BRIEF DESCRIPTION

In some illustrative embodiments disclosed as illustrative examples herein, a non-transitory storage medium stores instructions executable by an electronic data processing device to perform a max-string evaluation of a weighted finite state automaton (WFSA) A having initial state q₀ and final state q_{f} by operations including: generating an unweighted automaton B having the same states as the WFSA A and having unweighted transitions corresponding only to the transitions of the WFSA A having non-null weights; performing a powerset construction on the unweighted automaton B to generate a deterministic automaton B′ having states Q including an initial state Q₀ corresponding to the initial state q₀ of the WFSA A and a final state Q_{f} corresponding to the final state q_{f} of the WFSA A; for each state Q′ of the deterministic automaton B′ (1) defining a set of points L_{Q′} representing all vectors w′=w·a_{QQ′} where a_{QQ′} is a transition label of a dominator of a predecessor state Q connecting predecessor state Q with state Q′ and w is a prefix of the transition label a_{QQ′} in predecessor state Q and (2) determining a set of dominators S_{Q′} in L_{Q′} such that L_{Q′} is included in hull(S_{Q′}); identifying the dominant vector w_{f} in the final state Q_{f} such that L_{Q}_{_{f}} is included in hull(w_{f}); and following backpointers from the dominant vector w_{f} to the initial state Q₀ to generate the max-string result.

In some illustrative embodiments disclosed as illustrative examples herein, a method is disclosed for performing a max-string evaluation of a weighted finite state automaton (WFSA) A having initial state cm and final state q_{f′} the method comprising: (i) generating an unweighted automaton B having the same states as the WFSA A and having unweighted transitions corresponding only to the transitions of the WFSA A having non-null weights; (ii) generating a deterministic automaton B′ from the unweighted automaton B, the deterministic automaton B′ having states Q including an initial state Q₀ corresponding to the initial state q₀ of the WFSA A and a final state Q_{f} corresponding to the final state q_{f} of the WFSA A; (iii) for each state Q′ of the deterministic automaton B′ including the final state Q (1) defining a set of points L_{Q′} representing all vectors w′=w·a_{QQ′} where a_{QQ′} is a transition label of a dominator of a predecessor state Q connecting predecessor state Q with state Q′ and w is a prefix of the transition label a_{QQ′} in predecessor state Q and (2) determining a set of dominators S_{Q′} in L_{Q′} such that L_{Q′} is included in hull(S_{Q′}) where hull( . . . ) is one of the convex-hull, the ortho-hull, and the ortho-convex-hull; (iv) identifying the dominant vector w_{f} in the final state Q_{f} such that L_{Q}_{_{f}} is included in hull(w_{f}); and (v) following backpointers from the dominant vector w_{f} to the initial state Q₀ to generate the max-string result. The operations (i), (ii), (iii), (iv), (v), and (vi) are suitably performed by an electronic data processing device.

In some illustrative embodiments disclosed as illustrative examples herein, an apparatus comprises an electronic data processing device programmed to perform a max-string evaluation of a weighted finite state automaton (WFSA) having an initial state and a final state by operations including: (i) generating an unweighted automaton having the same states as the WFSA and having unweighted transitions corresponding only to the transitions of the WFSA having strictly positive weights; (ii) generating a deterministic automaton from the unweighted automaton, the deterministic automaton having states including an initial state corresponding to the initial state of the WFSA and a final state corresponding to the final state of the WFSA; (iii) for each state Q′ of the deterministic automaton (1) defining a set of points L_{Q′} representing all vectors w′=w·a_{QQ′} where a_{QQ′} is a transition label of a dominator of a predecessor state Q connecting predecessor state Q with state Q′ and w is a prefix of the transition label a_{QQ′} in predecessor state Q and (2) determining a set of dominators S_{Q′} in L_{Q′} such that L_{Q′} is included in a region defined by the set of dominators S_{Q′} and encompassing the set of points L_{Q′}; (iv) identifying the dominant vector w_{f} in the final state Q_{f} of the deterministic automaton that defines a region that encompasses the set of points L_{Q}_{_{f}}; and (v) following backpointers from the dominant vector w_{f} to the initial state Q₀ to generate the max-string result.

### BRIEF DESCRIPTION OF THE DRAWINGS

FIG. 1 diagrammatically shows an illustrative translation system.

FIG. 2 diagrammatically shows an illustrative transcription system.

FIG. 3 diagrammatically shows a max-string evaluation module suitably used in either or both systems of FIGS. 1 and 2.

FIGS. 4-6 diagrammatically show the convex-hull, ortho-hull, and ortho-convex-hull, respectively, of an illustrative set of points X={1,2,3,4,5,6,7}.

FIG. 7 diagrammatically shows a process operation performed by the max-string evaluation module of FIG. 3.

FIG. 8 diagrammatically shows enhancement of the efficiency of the max-string evaluation performed by the max-string evaluation module of FIG. 3 obtained by identifying dominators using a hull operation.

### DETAILED DESCRIPTION

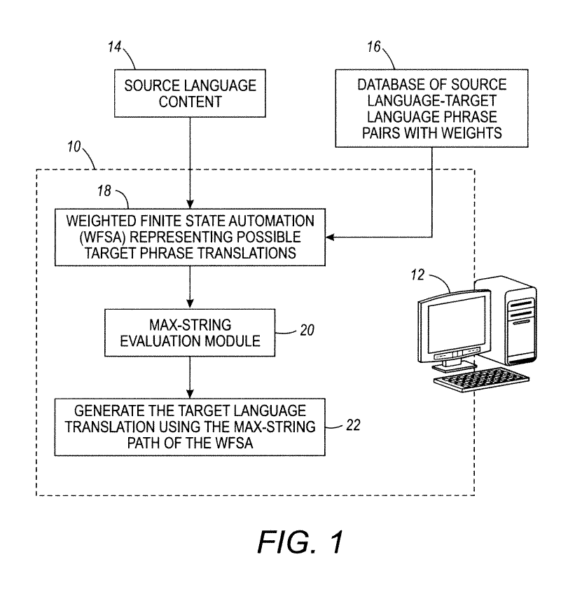

With reference to FIG. 1, a translation system 10 is implemented by a computer or other electronic data processing device 12 that includes a processor (e.g., microprocessor, optionally multi-core) and data storage and executes instructions to perform natural language translation from a source language to a target language (that is, executes a natural language translation program or executes natural language translation software). The translation system 10 receives source language content 14 to be translated, and also has access to a database 16 of source language-target language phrase pairs, typically with some probabilistic or likelihood statistics or weighting values. The translation system 10 generates a weighted finite state automaton (WFSA) 18 representing possible translations of the source language content 14. In some embodiments, this WFSA can take the form of a weighted word graph over target language words as described in Ueffing et al., “Generation of Word Graphs in Machine Translation”, EMNLP 2002 (available at http://www.aclweb.org/anthology-new/W/WO2/WO2-1021.pdf, last accessed Aug. 7, 2012). The transitions of the WFSA 18 are labeled with words of a vocabulary V (where the “words” may include multi-word terms) and the paths through the WFSA 18 define a vocabulary V* of strings representing possible translations of the source language content 14. The WFSA 18 is processed by a max-string evaluation module 20 to identify the max-string solution x in the vocabulary V* of the WFSA 18. In an operation 22, the target language translation is generated using the max-string solution x. For example, the operation 22 may comprise constructing a target-language textual string (i.e., the translation) corresponding to the max-string solution x.

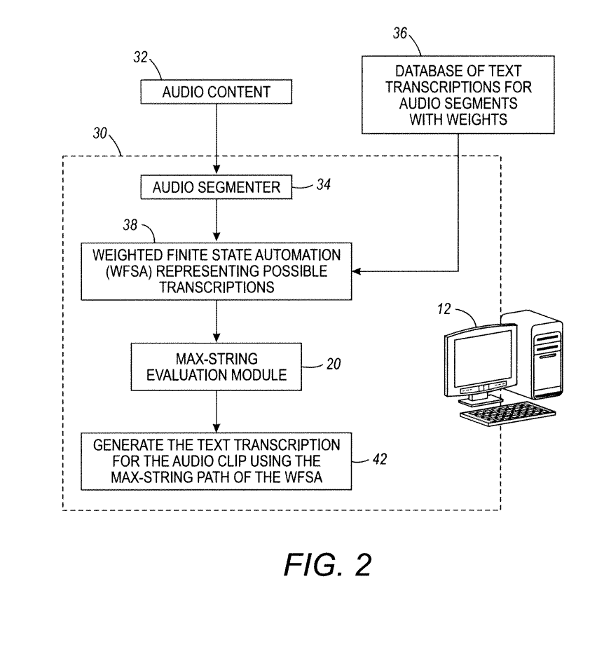

With reference to FIG. 2, an audio transcription system 30 is implemented by the computer or other electronic data processing device 12 executing instructions to perform audio transcription (that is, executing an audio transcription program or executing audio transcription software). The audio transcription system 30 receives audio content 32, and an audio segmenter 34 segments the audio content 32 into audio segments corresponding to words. The segmentation may, for example, be based on identifying low volume or silent regions between words. The audio transcription system 30 also has access to a database 36 of text transcriptions for audio segments corresponding to words, typically with some probabilistic or likelihood statistics or weighting values. The audio transcription system 30 generates a weighted finite state automaton (WFSA) 38 representing possible transcriptions of the (segmented) audio content 32. In some embodiments, the WFSA corresponds to a word graph where the nodes are labeled by time points. See, e.g. Oerder and Ney, “Word graphs: an efficient interface between continuous-speech recognition and language understanding”, ICASSP 1993. The transitions of the WFSA 38 are labeled with transcribed words of a vocabulary V (where the “words” again may include multi-word terms) and the paths through the WFSA 38 define a vocabulary V* of strings representing possible transcriptions of the audio content 32. The WFSA 38 is processed by the max-string evaluation module 20 to identify the max-string solution x in the vocabulary V* of the WFSA 38. In an operation 42, the transcribed text is generated using the max-string solution x. For example, the operation 42 may comprise constructing a transcribed textual string corresponding to the max-string solution x.

The max-string evaluation module 20 may be hard-coded into the translation software of the system of FIG. 1 and/or into the audio transcription software of the system of FIG. 2. Alternatively, the max-string evaluation module 20 may be a library function or other self-contained software module that executes on the computer or other electronic data processing device 12 and is invoked by the translation system 10 and/or by the audio transcription system 30 to perform max-string evaluation. Moreover, it is to be understood that the translation system 10 and audio transcription system 30 are merely illustrative applications, and that more generally the max-string evaluation module 20 can be employed in substantially any application that benefits from performing a max-string evaluation of a WFSA.

It is also to be understood that the translation functionality described with reference to FIG. 1 and/or the audio transcription functionality described with reference to FIG. 2 (in either or both cases including the max-string evaluation) may additionally or alternatively be embodied as a non-transitory storage medium (not shown) storing instructions executable to perform that functionality. The non-transitory storage medium may, for example, comprise one or more of the following: a hard disk or other magnetic storage medium; random access memory (RAM), read-only memory (ROM), or another electronic storage medium; an optical disk or other optical storage medium; a combination of the foregoing, or so forth.

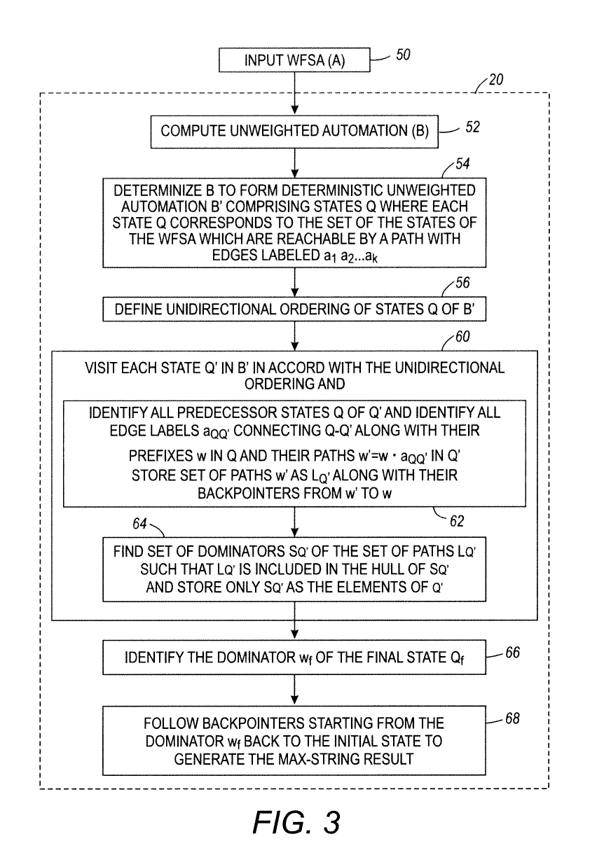

With reference to FIG. 3, an illustrative embodiment of the max-string evaluation module 20 is described. The input is an acyclic weighted finite-state automaton (WFSA) 50 represented as A. The WFSA 50, may, for example, be the WFSA 18 representing possible target-language translations (see FIG. 1), or may be the WFSA 38 representing possible audio transcriptions (see FIG. 2). The WFSA 50 is an automaton A on a vocabulary V (the elements of V are called “words” herein). The set of all the strings over the vocabulary V is denoted by V*, and each path through the WFSA A defines a string. The WFSA A has weights in the set of non-negative reals=[0,∞), which are assumed to be combined multiplicatively (as is the case with probabilities). The max-string evaluation identifies the string x in V* that maximizes the sum of the weights of all the paths that yield x. The max-string problem can be viewed as working in the sum-times semiring K_{S}≡( [symbol] ,+,·,0,1).

One approach to the max-string problem is to enumerate all the paths, summing the weights of paths corresponding to the same string, and then output the string having the maximum sum of weights over all paths. However, such an exhaustive approach is not computationally practical in larger-scale problems. Another approach is based on recognizing that, in the case of a deterministic weighted automaton, the max-string and max-path problems coincide, and therefore in trying to determinize the automaton. However, determinizing a weighted automaton over the sum-times semiring K_{S} tends to lead to combinatorial explosion, even in cases where the classical (unweighted) determinization of the WFSA does not explode.

The approach disclosed herein and described with reference to FIG. 3 is of reasonable computational complexity and is unlikely to lead to combinatorial explosion.

It is assumed herein that the automaton A (i.e. WFSA 50 of FIG. 3) has exactly one initial state q₀ and one final state q_{f}, and also that the state q_{f} can only be entered through edges labelled with a special end-marker denoted herein as “$”. These conditions are not restrictive, as any WFSA A can be transformed into this form simply by adding to any final state of the initial automaton an outgoing edge of weight 1 with label “$” and target q_{f}.

Each word aεV (including the special word “$”) can be associated with a transition matrix of dimension D×D over the non-negative reals where D is the number of states in A. The initial state q₀ (resp. the final state q_{f}) of the automaton can be identified with the D-dimensional vector (1,0, . . . , 0) (resp. the vector (0,0, . . . , 1)), and the distribution of weights over the states of A after having seen the string a₁a₂ . . . aₖ is then given by the D-vector (1,0, . . . ,0)·a₁·a₂ . . . ·aₖ, where the a₁, . . . , aₖ's are identified with matrices. The weight of a string of the form a₁a₂ . . . aₚ$ is then equal to the single coordinate of the one-dimensional vector (1,0, . . . ,0)·a₁·a₂ . . . ·aₚ·$·(0,0, . . . , 1)T.

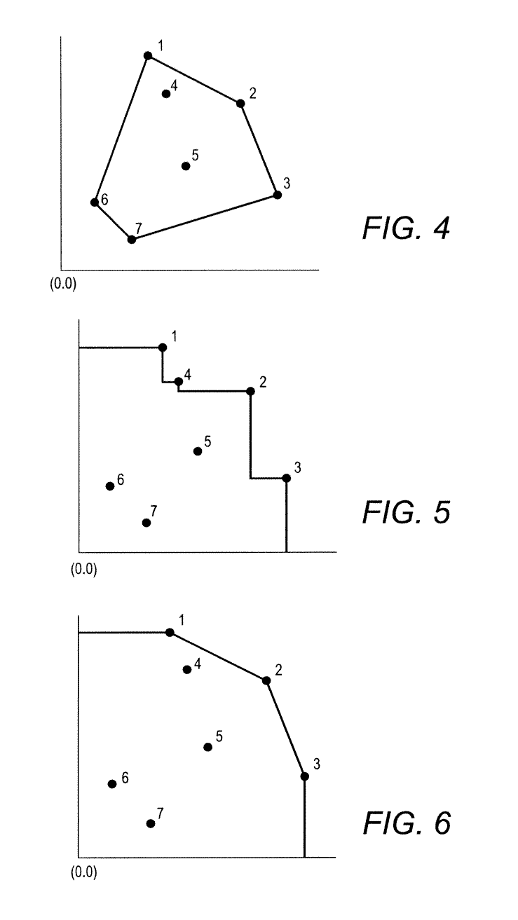

With brief reference to FIGS. 4-6, the disclosed max-string evaluation utilizes the concept of hulls. A hull of a (finite or infinite) set of points in a space is an envelope of minimum size, and obeying specified boundary constraints, that contains the entire set of points. In the following, three illustrative hulls are disclosed: a convex-hull (FIG. 4); an ortho-hull (FIG. 5); and an ortho-convex-hull (FIG. 6). In these illustrative examples, let u be a d-dimensional vector (d not necessarily equal to D) and S be a set (finite or not) of d-dimensional vectors over the non-negative reals. The illustrative examples of FIGS. 4-6 consider the set of points X={1,2,3,4,5,6,7} in an illustrative two-dimensional space. (That is, the set S=X={1,2,3,4,5,6,7} with d=2 in the illustrative examples).

With particular reference to FIG. 4, the convex-hull (or c-hull) is defined as follows. The vector u is in the convex-hull (or c-hull) of S if and only if (iff) u can be written as a finite sum u=Σⱼαⱼsⱼ, with sⱼεS, jε[1,m],Σⱼαⱼ=1,αⱼ≧0. In the illustrative convex-hull of FIG. 4, the set of points X is included in the convex-hull of [1,2,3,6,7] (but no smaller set). The convex hull can be visualized as the shape circumscribed by a rubber band stretched around the set of points.

With particular reference to FIG. 5, the ortho-hull (or O-hull) is defined as follows. The vector u is in the ortho-hull (or O-hull) of S iff there exists a vector vεS subject to (s.t.) u≦v (where u≦v is a vector inequality, i.e. u≦v holds iff uᵢ≦vᵢ for all dimensions i=1, . . . , d). The ortho-hull is in general not convex. In the illustrative convex-hull of FIG. 5, the set of points X is included in the ortho-hull of {1,2,3,4} (but no smaller set).

With particular reference to FIG. 6, the vector u is in the ortho-convex-hull (or oc-hull) of S if u is in the ortho-hull of the convex-hull of S. The ortho-convex-hull is convex. In the illustrative convex-hull of FIG. 6, the set of points X is included in the ortho-convex-hull of {1,2,3} (but no smaller set).

With the foregoing hull definitions, the following lemma can be shown to hold. Let a be a d×d matrix over the non-negatives reals, and S be as before. Denote by a(S) or by S·a the image of S by the linear transformation associated with a. Then the following lemma holds: If u is in the convex-hull (resp. ortho-hull, ortho-convex-hull) of S, then a(u) is in the convex-hull (resp. ortho-hull, ortho-convex-hull) of a(S). This lemma can be demonstrated as follows. If u is in the convex-hull of S, then u=Σᵢ αᵢsᵢ, with sᵢεS and Σᵢ αᵢ=1, αᵢ≧0; hence u·a=Σᵢ αᵢsᵢ·a, which implies that u·a is in the convex-hull of a(S). If u is in the ortho-hull of S, then there exists v in S s.t. u≦v; therefore v−u≧0 and, because a has non-negative coefficients, (v−u)·a≧0, therefore u·a≦v·a, which implies that u·a is in the ortho-hull of a(S). Finally, if u is in the ortho-convex-hull of S, then uεo−hull(c−hull(S)), hence a(u)εo−hull(a(c−hull(S))⊂o−hull(c−hull(a(S)) by the two previous facts and by the monotonicity of the various hull operations relative to set inclusion.

With reference back to FIG. 3, the hull concept described above with reference to FIGS. 4-6 is applied to perform max-string evaluation as follows. In an operation 52, the unweighted Let B be the unweighted, or “boolean” automaton B associated with WFSA A 50 is computed. In the unweighted or boolean automaton B, the states of B are those of A, and all the edges of WFSA A that carry a strictly positive weight are associated with unweighted edges of B. In an operation 54, a powerset construction (see, e.g. “Powerset construction”, https://en.wikipedia.org/wiki/Powerset_construction (last accessed Jul. 24, 2012)) is applied to determinize the automaton B into the deterministic automaton B′, where a state Q in B′ is a set Q=q₁, . . . , qₘ where q₁, . . . , qₘ are states of B. A state Q=q₁, . . . , qₘ appears in B′ iff there exists a string of words a₁a₂ . . . aₖ such that Q is exactly the set of states in A that are reachable from the initial state q₀ of A by following some path labelled with a₁a₂ . . . aₖ. Any string a₁a₂ . . . aₖ which reaches at least one state of B reaches a single Q in B′, but several such strings can reach the same Q. The initial state for B is Q₀=q₀. Because A has exactly one final state q_{f} that can only be entered through edges labelled “$”, there is only one final state Q_{f} for B′, with Q_{f}=q_{f}; this state is reached by any string ending in $ which is accepted by B.

In view of the foregoing, it follows that if a is a word, and if Q,Q′ are states of B′, then there is an edge labelled with a between Q and Q′ iff there exists a string a₁a₂ . . . aₖaₖ₊₁ such that aₖ₊₁=a, a₁a₂ . . . aₖ reaches Q and a₁a₂ . . . aₖaₖ₊₁ reaches Q′.

With continuing reference to FIG. 3, in an operation 56 an enumeration order of the states of B′ is defined which respects the constraint that a state Q′ in the enumeration order is visited only after visiting all its predecessors Q. The deterministic nature of the automaton B′ ensures that such an enumeration order can always be defined. The subsequent set of process operations 60 visit each state Q′ in the deterministic automaton B′ in turn in accordance with the defined enumeration order of the states of B′.

Consider a string a₁a₂ . . . aₖ which reaches Q=q₁, . . . , qₘ in B′. If the matrices associated to the aᵢ terms in A are considered, it is seen that the D-dimensional vector w=(1,0, . . . , 0)·a₁·a₂ . . . ·aₖ has null values for the coordinates corresponding to states of A not in Q. Next consider the m-dimensional vector w_{Q}=proj_{Q}(w) which is the projection of w onto the coordinates Now consider an edge labelled a between Q and Q′, where Q′ is of cardinality m′. It is seen that the string a₁a₂ . . . aₖa reaches Q′, and determines the m′-dimensional vector w′_{Q′} =proj_{Q′}((1,0, . . . , 0)·a₁·a₂ . . . ·aₖ·a). The edge (Q, a, Q′) can be associated with an m×m′ non-negative matrix a_{QQ′}, which is obtained from the D×D matrix a by keeping only the coefficients corresponding to states in Q and Q′, and the relationship w′_{Q′}=w_{Q}·a_{QQ′} is obtained.

Now consider the finite set of cardinality N_{Q′} of all strings xⁱ, iε1, . . . , N_{Q} of the acyclic automaton that reach Q, where each xⁱ is a string of the form a₁ⁱ . . . aₖ_{ⁱ}ⁱ. This set generates a set W_{Q} of N_{Q} m-dimensional non-negative vectors w_{Q}ⁱ over the coordinates q₁, . . . , qₘ.

To improve computational efficiency, the processing operations 60 employ a hull, which may be a convex hull (e.g. FIG. 4), an ortho-hull (e.g. FIG. 5), or an ortho-convex-hull (e.g. FIG. 6). The same hull (convex, ortho, or ortho-convex) is employed throughout the processing 60.

Suppose that there exist a subset S_{Q} of cardinality K_{Q} of W_{Q} such that W_{Q} is included in the hull of S_{Q}. The subset S_{Q} is referred to as a set of dominators relative to W_{Q}. Without loss of generality, S_{Q} and W_{Q} can be written as S_{Q}=x¹, . . . , x^{K}^{_{Q}} and W_{Q}=x¹, . . . , x^{N}^{_{Q}}, respectively. Thus, for i>K_{Q′} w_{Q}ⁱ is not in S_{Q′} but is in the hull of S_{Q}.

Then consider any fixed word string y=b₁ . . . bₚ$ such that y moves from Q to Q_{f′} by traversing the states Q₁=Q, Q₂=b₁(Q₁), . . . , Qₚ₊₁=bₚ(Qₚ),Q_{f}=$(Qₚ₊₁). Then, for any i, the string xⁱy is accepted by the automaton A, and its weight is given by the product w_{Q}ⁱ·y_{Q,Q}_{_{f}} where he matrix y_{Q,Q}_{_{f}} is defined by y_{Q,Q}_{_{f}}=b_{1;Q}_{₁}_{Q}_{₂}, . . . , b_{p;Q}_{ₚ}_{Q}_{_{P+1}}·$_{Q}_{_{P+1}}_{Q}_{_{f}}. The product w_{Q}ⁱ·y_{Q,Q}_{_{f}} is a scalar because it is a product of matrices of dimensionality m×n where the last n is 1, the dimensionality of the space Q_{f}.

Suppose that w_{Q}ⁱ is in the hull of S_{Q′} but not in S_{Q}; then it is seen by induction that the image IMᵢ of w_{Q}ⁱ by the transformation y_{Q,Q}_{_{f}} is in the hull of the image IM_{S} of S_{Q} by that same transformation. Because IM_{S} is a subset of a one-dimensional space, there is some w_{Q}^{j} in S_{Q} such that its image IM₁ is the maximum of IM_{S}, and the hull of IMⱼ is then contained in the set of nonnegative reals smaller or equal to IMⱼ. This implies that IMᵢ≦IMⱼ. In other words, the weight of the string xⁱy is lesser than the weight of the string x^{j}y. As a consequence, to find the maximum weight of any string passing through Q, all strings xⁱ that do not end in a point of S_{Q} can be discarded.

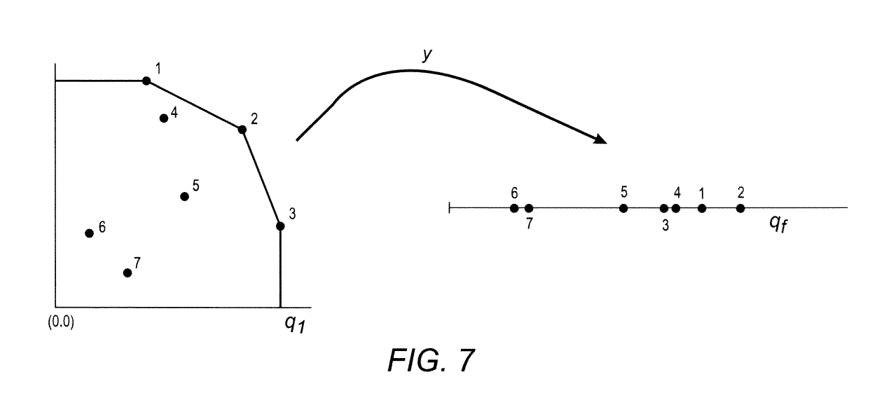

With brief reference to FIG. 7, this concept is illustrated by diagrammatic example. In the example of FIG. 7, the hull is an ortho-convex-hull (oc-hull). Building off of the example of FIG. 6, the diagram of FIG. 7 illustrates a situation where the strings x¹, . . . , x⁷ end up in the state Q=q₁,q₂, and where the corresponding vectors 1,2,3,4,5,6,7 are all in the oc-hull of 1,2,3. The image of the seven vectors by the transformation associated with y are then all in the oc-hull of the images of 1,2,3, that is, are all smaller than the largest of the images of 1,2,3, which in the case of this specific y, is the image of 2. Irrespective of which y is chosen, none of 4,5,6,7 may lead to such a maximum, and they can be discarded from further consideration.

Based on the foregoing, it is then of interest, given the set W_{Q′} to find the smallest possible set S_{Q}⊂W_{Q} such that W_{Q}⊂hull(S_{Q}).

In embodiments in which the hull is the convex-hull, there exist published algorithms based on a Linear Programming (LP) technique to find a minimal set S_{Q} in time bounded O(N_{Q}²), where the minimal set is the (unique) set of so-called extreme points of W_{Q}. See, e.g., T. Ottmann, S. Schuierer, and S. Soundaralakshmi, “Enumerating extreme points in higher dimensions”, in Symposium on Theoretical Aspects of Computer Science, pages 562-70 (1995).

In embodiments in which the hull is the ortho-hull, one method to find S_{Q} is to enumerate each point x of W_{Q′} and for each such point to enumerate all other points y in W_{Q} to check whether x≦y; if such an y is found, then x can be eliminated from W_{Q} and the process continued with the next x still in W_{Q′} otherwise y is included in S. This technique is of complexity bounded by O(N₂²).

In embodiments in which the hull is the ortho-convex-hull, the process of finding the smallest possible set S_{Q}⊂W_{Q} such that W_{Q}⊂hull(S_{Q}) can start by using the same technique as with the ortho-hull to produce a S_{Q,0} and then only keep the convex extreme points in S_{Q,0} in the sense just introduced for convex hulls. The resulting S_{Q} dominates all of W_{Q} in the oc-hull sense. The ortho-convex-hull has the advantage of producing a smaller S_{Q} than either the convex-hull or the ortho-hull.

While this last technique is reasonable in practice, it does not always produce a minimal S_{Q} relative to the oc-hull notion. For instance, in the left drawing of FIG. 7 the set S_{Q,0} is equal to 1,4,2,3, and 4 is just outside the convex hull of 1,2,3, so the optimal S_{Q} which is equal to 1,2,3 is not reached.

Another technique, also based on LP, that is able to reach the optimal S_{Q} for the ortho-convex-hull is as follows. The technique starts from a finite set X in the nonnegative orthant [symbol] ₊^{d}, is able to find a subset S of X such that X is contained in oc−hull(S). In most cases, this technique actually will find the minimal such subset, for instance when the points of X are in “general position”, that is, such that the only points of X which are exactly on a face of its convex hull are extreme points of X; otherwise it might include some points that are not strictly necessary. In the case of the data set of FIG. 6, the algorithm finds the optimal set 1,2,3. The approach starts with Λ₊≡\0. If λεΛ₊, and yεX, then the pair (λ,y) oc-dominates X iff λ·x≦λ·y, ∀xεX. Then Λ_{y} is defined as the subset of Λ₊ of those λ's such that (λ,y) oc-dominates X. If S is a subset of X, then S oc-dominates X iff, for any λεΛ₊, there exists an yεS s.t. (λ, y) oc-dominates X. Further defined is S_{X}≡yεX|Λ_{y}≠.

The approach is based on two lemmas. The first lemma is as follows: Let S be a subset of X. Then Xεoc−hull(S) if S oc-dominates X. This lemma can be shown as follows.

First, suppose that X⊂oc−hull(S), we want to prove that S oc-dominates X. We know by standard convexity theory that, for any λε [symbol] ^{d}, the function z→λ·z, for z taking its values in c−hull(S), attains its maximum on an element of S, a fortiori this is also true for any λε [symbol] ₊^{d}; hence S oc-dominates c−hull(S); because X⊂oc−hull(S), for every xεX, there exists an x′ in c−hull(S) with x≦x′, and let us consider the set X′⊂c−hull(S) of all such x′; it is clear that for any λεΛ₊, the projection of the set X on the direction defined by λ is dominated by the projection of X′ on that same direction, and we have just shown that this last projection is dominated by the projection of some element of S; hence X is oc-dominated by S.

Second, suppose conversely that S oc-dominates X, and assume that there is some xεX which is not in oc−hull(S); then if we denote by Oₓ the “orthant” above x, that is, the set of u's s.t. x≦u, then 0, is convex, closed, and is disjoint from c−hull(S), which is itself closed, and by the separation theorem of closed convex sets, there exists a separating hyperplane between Oₓ and c hull(S), defined by a certain direction A, containing x and such that (a) Oₓ is on the positive side of λ and (b) c−hull(S) on its negative side and at a strictly positive distance from the hyperplane; (a) implies that λεΛ₊ and (b) that λ·x>λ·s, for all sεS, which is contradictory with the fact that S oc-dominates X.

The second lemma is as follows: Sₓ oc-dominates X. This lemma can be shown as follows. We first remark that Λ₊=U_{xεX}Λₓ; this is because, for each λεΛ₊, there exists some yεX s.t. (λ,y) dominates X. Thus Λ₊ is the union of those Λ_{y} that are not empty. Hence, for every λεΛ₊, there exists an yεS_{X} s.t. (λ, y) dominates X, in other words S_{X} oc-dominates X.

We now describe the algorithm for computing Sₓ from the set X, of cardinality n. For each yεX, we need to decide whether Λ_{y} is empty or not, if yes, we put y in S_{X}, otherwise we do not. Thus, for a given y, we need to decide whether there exists a λεΛ₊ s.t. (λ,y) oc-dominates X, in other words ∀xεX, λ·x≦λ·y; we can always assume, by rescaling λ by a positive factor, that Σᵢλᵢ=1, where i is the index of the d-dimensional vector λ. This is equivalent to being able to decide whether the following set of linear constraints, in other word, the following linear program, has a solution: (1) The n constraints λ·(y−x)≧0, for x each element of the set X; (2) The d constraints λᵢ≧0, for the d coordinates of λ; and (3) The constraint Σᵢλᵢ=1. This LP thus has n+d+1 constraints, and, considering d as a constant, can be solved in time O(n). Thus the computation of S_{X} can be done in time O(n²).

As previously noted, the ortho-convex-hull has the advantage of producing a small set S_{Q} than either the convex-hull or the ortho-hull. However, in practice it may be advantageous to employ the ortho-hull S_{Q′} which, although larger, is simpler to program than the optimal ortho-convex-hull S_{Q}.

With continuing reference to FIG. 3, by way of review the max-string evaluation process thus far described includes operation 52 computing the unweighted (i.e., Boolean) automaton B and the operation 54 determinizing B to generate the deterministic unweighted automaton B′. The initial state Q₀ is associated with a one-dimensional space with the coordinate q₀ and the vector (1) in this space is stored. In the operation 56 a unilateral ordering of the states Q of B′ is defined which respects the constraint that it visits a state Q′ only after it has visited all its predecessors Q. The process operations 60 are then performed for each state Q′ in B′. These operations 60 include an operation 62 that identifies all predecessor states Q of Q′ and identifies all edge labels a_{QQ′} connecting Q-Q′ along with their prefixes w in Q and their paths w′=w·a_{QQ′} in Q′. In performing the operation 62, only the edge labels a_{QQ′} corresponding to the set of dominators S_{Q} are considered, and not the entire set of points L_{Q}. The operation 62 stores the set of paths w′ as L_{Q′} along with their backpointers from w′ to w. In an operation 64, the set of dominators S_{Q′} of the set of paths L_{Q′} is found such that L_{Q′} is included in the hull of S_{Q′}. The operation 64 stores only the set of dominators S_{Q′}, and discards the remaining points in L_{Q′} as they cannot contribute to the max-string result. In the next step along the unidirectional ordering defined in operation 56, the current state Q′ becomes the predecessor state Q, and in this next step only the dominators S_{Q} are retained and considered.

In one suitable approach, the operations 60 are performed as follows. On visiting the state Q′, the set L_{Q′} is initialized to the empty set. For each predecessor Q of Q′, for each word a connecting Q to Q′, and for every vector w stored in Q, the vector w′=w·a_{QQ′} is computed and added to the set L_{Q′}. A backpointer from w′ to w is also stored. Once this is done, a small (or ideally minimal) subset of dominators S_{Q′} is found in L_{Q′} such that L_{Q′} is included in hull(S_{Q′}). The elements of S_{Q′} are stored in Q′, while the remaining elements of L_{Q′} are discarded as they cannot contribute to the max-string result.

At the end of this process 60, unless the final state q_{f} is not reachable by any string (i.e. the automaton A generates the empty language), it follows that the final state Q_{f} contains a maximal element w_{f}. In an operation 66, this maximal vector w_{f} is found in the final state Q_{f}. The maximal vector w_{f} is the vector in Q_{f} that dominates all other vectors in Q_{f}. In other words, the vector w_{f} in the final state Q_{f} is the one for which L_{Q}_{_{f}} is included in hull(w_{f}). In an operation 68, the backpointers to the initial state are followed, and the corresponding string is output. This string is the solution to the max-string problem.

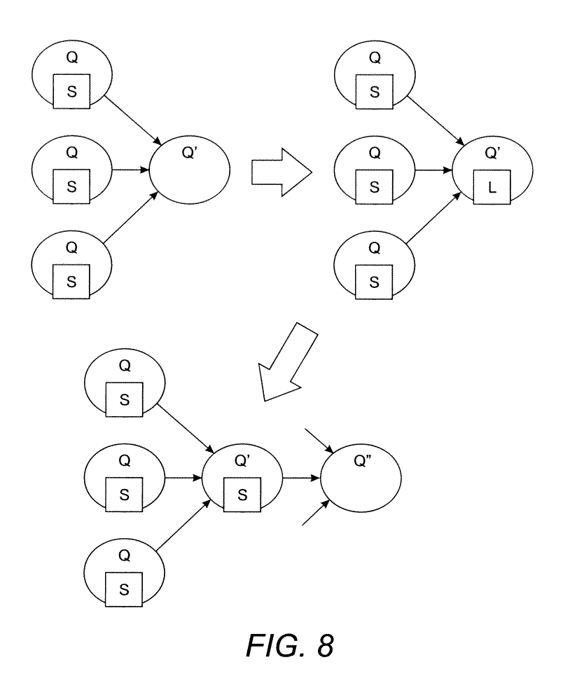

With reference to FIG. 8, the computational efficiency provided by defining the dominators S using the hull( . . . ) operation is diagrammatically illustrated. The upper left diagram of FIG. 8 shows the state of processing at the beginning of an iteration of the processing 60 of FIG. 3. At this point each of the predecessor states Q have their sets of dominators S_{Q} (denoted simply as S for simplicity in FIG. 8) defined through a previous iteration of the processing 60. The state Q′ shown in the upper left diagram of FIG. 8 is the state being visited in the current iteration of processing 60. The upper right diagram of FIG. 8 shows the processing after operation 62, where the entire set of points L_{Q′} has been generated. The operation 62 was made more efficient because in generating the set of points L_{Q′} only the dominators S_{Q} of the predecessor states Q were processed, rather than all points L_{Q} of the predecessor states. (This is because in the previous iteration of the processing 60 only the dominators S_{Q} were retained in operation 64). The bottom diagram of FIG. 8 shows the state of processing after execution of the current iteration of the operation 64. That operation identified and stored the dominators S for the currently visited state Q′ while the remainder of the points L for the state Q′ were discarded. The bottom diagram of FIG. 8 diagrammatically indicates the beginning of the next step of the iterative application of processing 60 by showing the “next visited” state Q″. (In describing FIG. 3, the state shown as Q″ is actually state Q′ for the next step, while the state Q′ now becomes a predecessor state Q).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A non-transitory storage medium storing instructions executable by an electronic data processing device to perform a max-string evaluation of a weighted finite state automaton (WFSA) A having initial state q₀ and final state q_{f} by operations including:
generating an unweighted automaton B having the same states as the WFSA A and having unweighted transitions corresponding only to the transitions of the WFSA A having strictly positive weights;
performing a powerset construction on the unweighted automaton B to generate a deterministic automaton B′ having states Q including an initial state Q₀ corresponding to the initial state q₀ of the WFSA A and a final state Q₁ corresponding to the final state q_{f} of the WFSA A;
for each state Q′ of the deterministic automaton B′ (1) defining a set of points L_{Q′} representing all vectors w′=w·a_{QQ′} where a_{QQ′} is a transition label of a dominator of a predecessor state Q connecting predecessor state Q with state Q′ and w is a prefix of the transition label a_{QQ′} in predecessor state Q and (2) determining a set of dominators S_{Q′} in L_{Q′} such that L_{Q′} is included in hull(S_{Q′});
identifying the dominant vector w_{f} in the final state Q_{f} such that L_{Q}_{_{f}} is included in hull(w₁); and
following backpointers from the dominant vector w_{f} to the initial state Q₀ to generate the max-string result.

2. The non-transitory storage medium as set forth in claim 1 wherein hull( . . . ) is one of the convex-hull, the ortho-hull, and the ortho-convex-hull.

3. The non-transitory storage medium as set forth in claim 1 wherein hull( . . . ) is the convex-hull wherein a vector u is in the convex-hull of S if and only u can be written as a finite sum u=Σⱼ αⱼsⱼ, with sⱼεS, jε[1,m], Σⱼαⱼ=1, αⱼ≦0.

4. The non-transitory storage medium as set forth in claim 1 wherein hull( . . . ) is the ortho-hull wherein a vector u is in the ortho-hull of S if and only if there exists a vector vεS subject to u≦v.

5. The non-transitory storage medium as set forth in claim 1 wherein hull( . . . ) is the ortho-convex-hull wherein a vector u is in the ortho-convex-hull of S if and only if it is in the ortho-hull of the convex-hull of S where:
a vector u is in the convex-hull of S if and only u can be written as a finite sum u=Σⱼ αⱼsⱼ, with sⱼεS, jε[1,m], Σⱼαⱼ=1,αⱼ≧0 and
a vector u is in the ortho-hull of S if and only if there exists a vector vεS subject to u≦v.

6. The non-transitory storage medium as set forth in claim 1 wherein the non-transitory storage medium stores further instructions executable by the electronic data processing device to generate a target natural language translation based on the generated max-string result.

7. The non-transitory storage medium as set forth in claim 1 wherein the non-transitory storage medium stores further instructions executable by the electronic data processing device to generate a transcription of audio content based on the generated max-string result.

8. An apparatus comprising:
the non-transitory storage medium as set forth in claim 1; and
an electronic data processing device operatively communicating with the non-transitory storage medium to execute the stored instructions.

9. A method to perform a max-string evaluation of a weighted finite state automaton (WFSA) A having initial state q₀ and final state q_{f}, the method comprising:
(i) generating an unweighted automaton B having the same states as the WFSA A and having unweighted transitions corresponding only to the transitions of the WFSA A having strictly positive weights;
(ii) generating a deterministic automaton B′ from the unweighted automaton B, the deterministic automaton B′ having states Q including an initial state Q₀ corresponding to the initial state q₀ of the WFSA A and a final state Q_{f} corresponding to the final state q_{f} of the WFSA A;
(iii) for each state Q′ of the deterministic automaton B′ including the final state Q_{f} (1) defining a set of points L_{Q′} representing all vectors w′=w·a_{QQ′} where a_{QQ′} is a transition label of a dominator of a predecessor state Q connecting predecessor state Q with state Q′ and w is a prefix of the transition label a_{QQ′} in predecessor state Q and (2) determining a set of dominators S_{Q′} in L_{Q′} such that L_{Q′} is included in hull(S_{Q′}) where hull( . . . ) is one of the convex-hull, the ortho-hull, and the ortho-convex-hull;
(iv) identifying the dominant vector w_{f} in the final state Q_{f} such that L_{Q}_{_{f}} is included in hull(w_{f}); and
(v) following backpointers from the dominant vector w_{f} to the initial state Q₀ to generate the max-string result;
wherein the operations (i), (ii), (iii), (iv), (v), and (vi) are performed by an electronic data processing device.

10. The method as set forth in claim 9 wherein the generating comprises:
performing a powerset construction on the unweighted automaton B to generate the deterministic automaton B′.

11. The method as set forth in claim 9 wherein hull( . . . ) is the convex-hull.

12. The method as set forth in claim 9 wherein hull( . . . ) is the ortho-hull.

13. The method as set forth in claim 9 wherein hull( . . . ) is the ortho-convex-hull.

14. The method as set forth in claim 9 further comprising:
(vii) generating a target natural language translation of source language content based on the generated max-string result;
wherein the generating operation (vii) is performed by the electronic data processing device.

15. The method as set forth in claim 9 further comprising:
(vii) generating a transcription of audio content based on the generated max-string result;
wherein the generating operation (vii) is performed by the electronic data processing device.

16. An apparatus comprising:
an electronic data processing device programmed to perform a max-string evaluation of a weighted finite state automaton (WFSA) having an initial state and a final state by operations including:
(i) generating an unweighted automaton having the same states as the WFSA and having unweighted transitions corresponding only to the transitions of the WFSA having strictly positive weights;
(ii) generating a deterministic automaton from the unweighted automaton, the deterministic automaton having states including an initial state corresponding to the initial state of the WFSA and a final state corresponding to the final state of the WFSA;
(iii) for each state Q′ of the deterministic automaton (1) defining a set of points L_{Q′} representing all vectors w′=w·a_{QQ′} where a_{QQ′} is a transition label of a dominator of a predecessor state Q connecting predecessor state Q with state Q′ and w is a prefix of the transition label a_{QQ′} in predecessor state Q and (2) determining a set of dominators S_{Q′} in L_{Q′} such that L_{Q′} is included in a region defined by the set of dominators S_{Q′} and encompassing the set of points L_{Q′};
(iv) identifying the dominant vector w_{f} in the final state Q_{f} of the deterministic automaton that defines a region that encompasses the set of points L_{Q}_{_{f}}; and
(v) following backpointers from the dominant vector w_{f} to the initial state Q₀ to generate the max-string result.

17. The apparatus as set forth in claim 16 wherein:
the region defined by the set of dominators S_{Q′} and encompassing the set of points L_{Q′} is one of the convex-hull of S_{Q′}, the ortho-hull of S_{Q′}, and the ortho-convex-hull of S_{Q′} and
the dominant vector w_{f} defines said region that encompasses the set of points L_{Q}_{_{f}} as one of the convex-hull of w_{f}, the ortho-hull of w_{f}, and the ortho-convex-hull of w_{f}.

18. The apparatus as set forth in claim 16 wherein the generating (ii) comprises:
performing a powerset construction on the unweighted automaton to generate the deterministic automaton.

19. The apparatus as set forth in claim 16 wherein the electronic data processing device is programmed generate a target natural language translation of source language content based on the generated max-string result.

20. The apparatus as set forth in claim 16 wherein the electronic data processing device is further programmed to generate a transcription of audio content based on the generated max-string result.
